(19) United States
(12) Patent Application Publication
(10) Pub. No.: US 2021/0204523 A1
(43) Pub. Date: Jul. 8, 2021

(54) COMBINED POULTRY ROOST AND WASTE ROUTING APPARATUS

(71) Applicant: Benjamin Joseph LOGAN, LAPEER, MI (US)

(72) Inventor: Benjamin Joseph LOGAN, LAPEER, MI (US)

(21) Appl. No.: 17/189,920

(22) Filed: Mar. 2, 2021

Related U.S. Application Data
(60) Provisional application No. 62/956,962, filed on Jan. 3, 2020.

(51) Int. Cl. A01K 31/12; A01K 45/00

(52) U.S. Cl. CPC A01K 31/12; A01K 45/00

(57) ABSTRACT

A combined poultry roost and waste routing apparatus includes a main tray member having floors, side walls and a peripheral frame portion. A catch basin, including a drainage outlet, is formed in a first end portion of the main tray member. The apparatus also includes a plurality of roosting bars attached to the main tray member, and a support stand supporting the main tray member at an inclined angle with the catch basin at a lower end thereof. A water supply manifold is operatively attached to a second end of the main tray member for selectively supplying rinse water thereto. The water supply manifold includes an inlet portion configured to receive a hose connection, and a fluid dispersion member attached to, and in fluid communication with the inlet portion. The fluid dispersion member has a plurality of openings formed therein for selectively releasing rinse water into the main tray member.

### CROSS-REFERENCE TO RELATED APPLICATIONS

1. This application is based upon, and claims priority from U.S. Provisional Patent Application No. 62/956,962, filed Jan. 3, 2020. The entire contents of the referenced priority application are incorporated herein by reference.

### BACKGROUND OF THE INVENTION

### Field of the Invention

The present invention relates to a combined poultry roost and waste routing apparatus for use by poultry farmers and hobbyists.

More particularly, the present invention relates to a combined poultry roost and waste routing apparatus including a main tray member supported at an incline and having roosting bars thereon, and a water supply manifold for selectively rinsing waste out of the main tray member.

### Description of the Background Art

Backyard chicken keeping is a popular hobby which can be rewarding with the collection of eggs, but can also be labor intensive due to the general upkeep and clean up of the chicken coop and immediate area. Chickens seem to be near-constantly eating, and also near-constantly depositing waste produced by the food that they digest.

Most chicken coops have roosting bars, and that is where the chickens sleep and spend a great portion of their day. The same chickens tend to roost in the same spots, respectively, and hence their waste deposits build up in the spots underneath their roosting sites. This requires the chicken keeper to repetitively scrape and clean this area, and dispose of the collected waste material.

Some chicken coops have a wire mesh floor and a collection pan underneath the floor, which is intermittently pulled out and emptied by the chicken keeper. This method is messy for the chicken keeper and can be uncomfortable for the chickens, as they may have to stand on this wire mesh when they are not on a perch.

The present invention provides a combined poultry roost and waste routing apparatus which is designed to improve on the situations described above and to create a cleaner and healthier environment for the chickens and for the chicken keepers.

### SUMMARY OF THE INVENTION

A combined poultry roost and waste routing apparatus according to the present invention combines a poultry roost and selectively rinseable toilet area for chickens.

The apparatus includes a main tray member which is supported by legs that hold it in an inclined angular position, and this allows for the roosting of multiple birds, and also allows for the downward flow of water and waste material inside of the main tray member. Chickens may roost on the perches of the inventive apparatus, and when they produce waste material, it will fall into the main tray member of the apparatus.

The main tray member has a peripheral frame portion, a floor and side walls interconnecting the floor and the frame portion. The main tray member also has a catch basin formed in a first, or lower end portion thereof. The catch basin of the main tray member has a drainage outlet formed therein. Optionally, the floor of the main tray member may have a plurality of reinforcing ribs formed therein.

In addition to the main tray member, the apparatus according to the illustrative embodiment includes a support stand, configured to support the main tray member at an inclined angle with the catch basin disposed at a lowermost end thereof.

The combined poultry roost and waste routing apparatus according to the illustrative embodiment further includes a plurality of roosting bars attached to, and extending horizontally across the peripheral frame of the main tray member. Optionally, but not necessarily, the peripheral frame portion of the main tray member may have a plurality of opposed recesses formed therein, and the roosting bars may be supported between these recesses.

The apparatus also includes a water supply manifold for selectively supplying rinse water into the main tray member to permit cleaning thereof. The water supply manifold is operatively attached to a second, or upper end of the main tray member, opposite the catch basin, The water supply manifold includes an inlet portion configured to receive a hose connection and a fluid delivery tube attached to and in fluid communication with the inlet portion. The fluid delivery tube has a plurality of orifices formed therein for selectively releasing rinse water into the main tray member. The water supply manifold is configured to be connected to a pressurized water supply, and the drain may be connected to an outlet pipe which leads out to a desired area for disposal of the waste.

Optionally, a releasable baffle plate may be provided in the main tray member below the water supply manifold, for temporarily impeding water flow therepast, and for directing water flow to the floor of the main tray member when it is released.

To clean or “flush” the main tray member of the apparatus, the chicken keeper opens a valve to the water supply manifold, which disperses pressurized water across and down the main tray member of the apparatus. This flow of water flushes the pan clean, and the waste matter flows into the drain and out through the drain pipe to be deposited in the desired area. This flushing operation could be conducted manually by the chicken keeper or it could be automated with the addition of a simple timer to turn the water pressure on at any desired interval. The drainage pipe could be directed to any desired area or into a collection system where the waste material could be collected for fertilizer.

For a more complete understanding of the present invention, the reader is referred to the following detailed description section, which should be read in conjunction with the accompanying drawings. Throughout the following detailed description and in the drawings, like numbers refer to like parts.

### BRIEF DESCRIPTION OF THE DRAWINGS

FIG. 1 is an isometric perspective view of a combined poultry roost and waste routing apparatus 10 according to a first illustrative embodiment of the present invention.

FIG. 2 is a perspective view of a main tray member of the apparatus according to the first embodiment.

FIG. 3 is a first perspective view of a combined poultry roost and waste routing apparatus 10 according to a second illustrative embodiment of the present invention, shown from a vantage point slightly above the apparatus.

FIG. 4 is a second perspective view of the apparatus of FIG. 3, shown from a vantage point slightly below the apparatus.

FIG. 5 is a perspective view of a main tray member of the apparatus according to the second embodiment.

FIG. 6 is a perspective view of the apparatus according to the second embodiment similar to FIG. 3, but also showing a second identical apparatus next to the original apparatus, to illustrate connection and joint operation.

FIG. 7 is a first perspective view of a combined poultry roost and waste routing apparatus according to a third illustrative embodiment of the present invention, shown from a vantage point slightly above the apparatus and showing a baffle in a first position configured to accumulate rinse water; and

FIG. 8 is a second perspective view of the combined poultry roost and waste routing apparatus similar to FIG. 7, but showing the baffle in a second position configured to release the rinse water.

### DETAILED DESCRIPTION OF ILLUSTRATIVE EMBODIMENTS

### First Embodiment

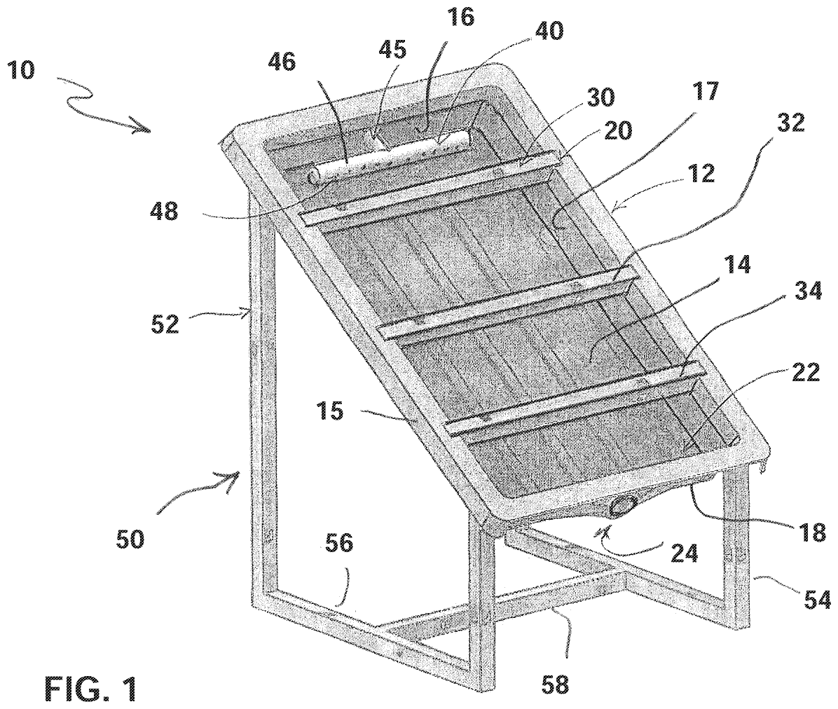

FIG. 1 is an isometric perspective view of a combined poultry roost and waste routing apparatus 10 according to a first illustrative embodiment of the present invention. The inventive apparatus 10 combines a poultry roost and a selectively rinseable toilet area for chickens.

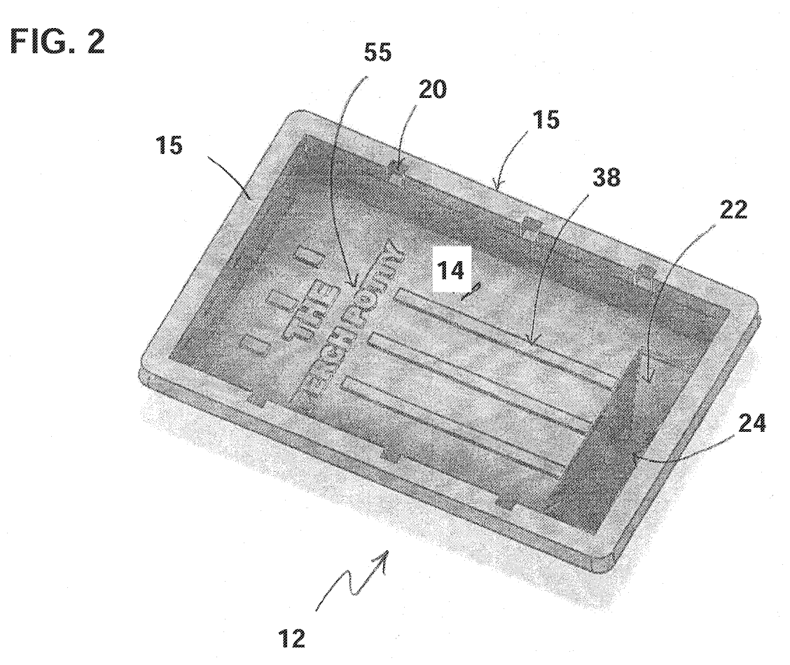

The inventive apparatus 10 includes a main tray member 12 which could be formed or fabricated from any appropriate material. FIG. 2 is a perspective view of a main tray member of the apparatus according to the first embodiment, modified by moving a catch basin from its location in FIG. 1.

The main tray member 12 is a primary component of the apparatus 10. The depicted main tray member 12 is formed from a durable plastic which has been vacuum formed. The main tray member 12 includes a floor panel 14, a peripheral frame 15 and a plurality of side walls 16, 17, 18 and 19 interconnecting the floor panel and the frame.

A catch basin 22 is molded into the bottom of the main tray member 12 at the lower end thereof, opposite a water supply manifold 40 disposed at the upper end. The catch basin 22 has a drainage hole 24 formed therein, and an optional pipe connection (not shown) of suitable diameter may be attached to the drainage hole to efficiently drain waste water from the cleaning or flushing operation.

Although the catch basin 22 is shown formed in the lowermost side wall 18 in FIG. 1, it may alternatively be situated at the lowermost part of the floor panel 14, as shown in FIG. 2, or may be formed in the lowermost corner of the main tray member between the side wall and the floor panel.

Optionally, the floor panel 14 of the main tray member 12 may have reinforcing ribs 38 formed integrally therein for added stiffness, and may also include molded-in lettering or other indicia 55 for brand identification.

The main tray member 12 also includes the peripheral frame 15, having indented recesses 20 formed therein, as shown, which serve to locate and secure a plurality of parallel roosting bars 30, 32, 34 in the frame, and these roosting bars may be secured by screws or other suitable fasteners extending through the side walls of the main tray member and into the ends of the roosting bars. It should be noted that the roosting bars 30, 32, 34 are spaced upwardly away from the floor panel 14 of the main tray member 12 to leave open space therebelow and ensure a clear pathway for waste to move downwardly on the floor panel.

As one example, 2″×2″ square wooden bars may be used as the roosting bars 30, 32, 34, but other materials and/or shapes could be substituted.

The water supply manifold 40 is secured at the top of the main tray member 12, and is configured to be connected to a pressurized water supply via a suitable hose connection. The water supply manifold 40 includes an inlet pipe 45 and a fluid dispersion pipe 46 attached to and in fluid communication with the inlet pipe.

In this first embodiment, the fluid dispersion member 46 is capped on both ends, and is perforated with line of small spaced-apart openings 48 that are configured to disperse pressurized water in an even pattern down the floor 14 of the main tray member 12.

The main tray member 12 is supported in an inclined angular fashion by a support frame 50, so as to accommodate roosting of multiple birds at different heights on the roosting bars 30, 32, 34 and also to facilitate the downward flow of waste water during cleaning for efficient drainage. The support frame 50 can be fabricated from a number of different materials, in the depicted embodiment, simple 2″×2″ wooden legs 52, 54 are used, interconnected by reinforcing members 56 and 58.

A single apparatus 10 can be connected to a water supply and drainage system, or alternatively, two or more units can be connected together by use of suitable connectors for the supply and drainage lines, and therefore, a user may accommodate any number of birds.

### Second Embodiment

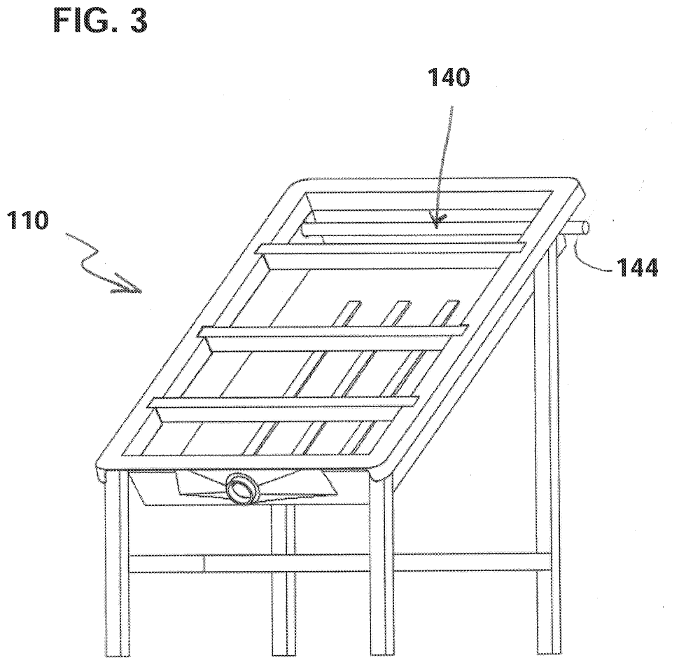

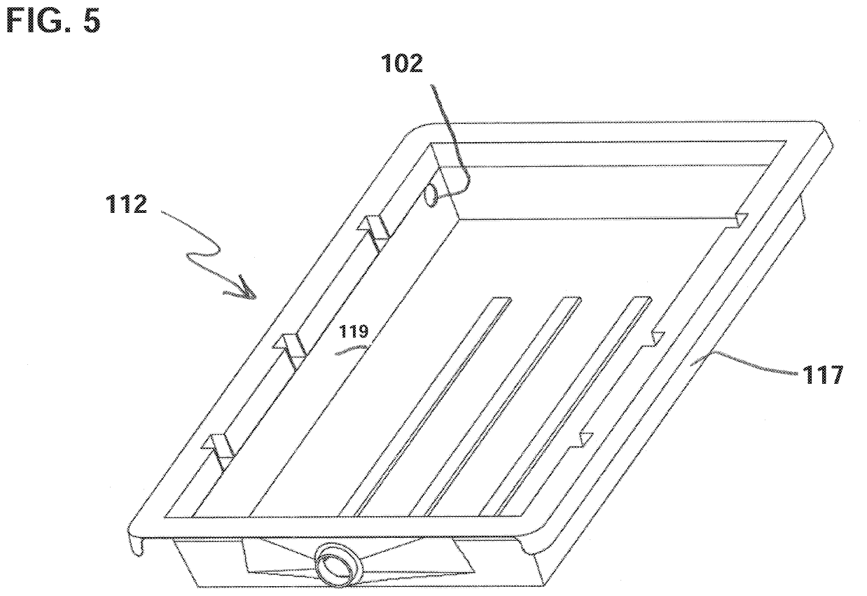

Referring now to FIGS. 3-6, a combined poultry roost and waste routing apparatus 110 according to a second embodiment of the present invention will now be described. The apparatus 110 according to the second embodiment is substantially identical to the apparatus 10 according to the first embodiment as previously described, with the exception that the main tray member 112 and the water supply manifold 140 in the second embodiment are arranged and configured differently from the main tray member 12 and the water supply manifold 40 of the first embodiment. For this reason, redundant description of identical parts will be avoided.

In this second embodiment of the invention, the upper end portion of the main tray member 112 has two opposed holes 102, 104 formed in opposite side walls 119, 117 thereof, and the water supply manifold 140 consists of a single perforated pipe acting as a fluid delivery tube, which extends through these two holes. In a manner similar to the first embodiment, the perforated pipe 140 has a plurality of orifices formed therein for selectively releasing rinse water into the main tray member 112.

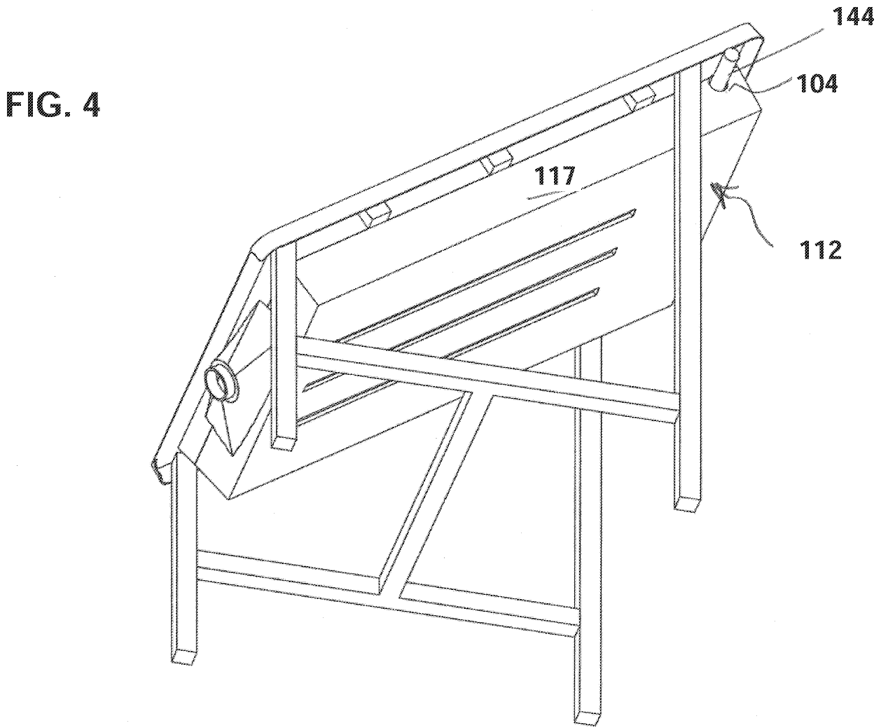

The terms “water supply manifold 140” and “perforated pipe 140” will be used interchangeably herein and refer to the same thing. As seen in FIGS. 3 and 4, the central part of the perforated pipe 140 extends across the main tray member between the side walls 117, 119 thereof, and end portions extend of the perforated pipe extend outside of the main tray member.

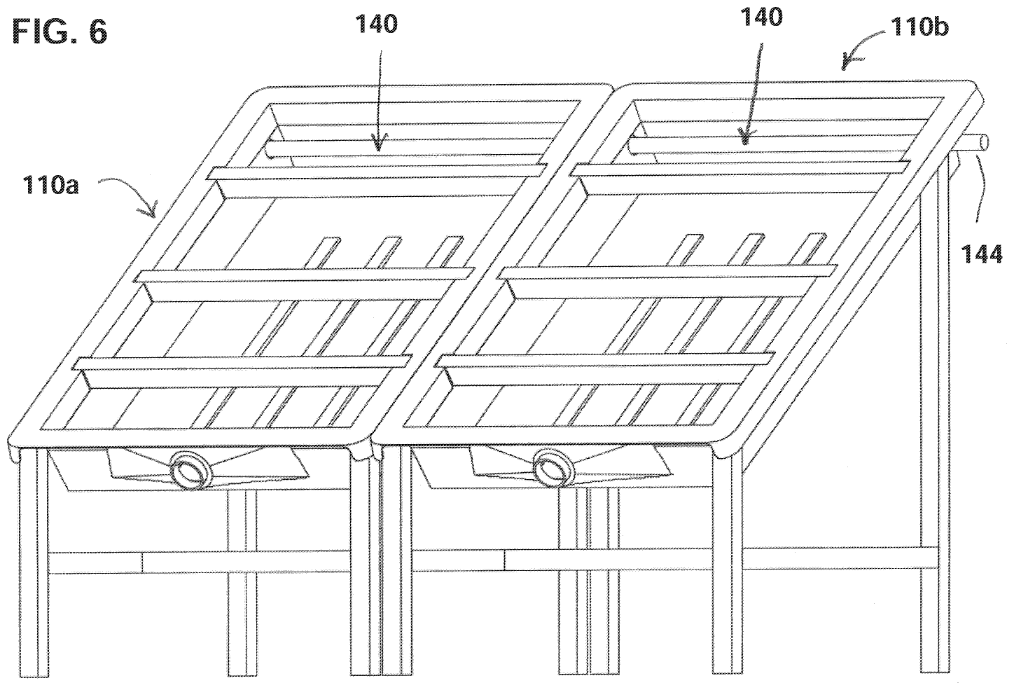

If a single apparatus is being used, then one end of the perforated pipe 140 is capped off with a suitable fitting, and the other end 144 is provided with a hose fitting (not shown) for connection to a high-pressure water supply. If multiple apparatus are being connected together, such as the two apparatus 110a, 110b shown in FIG. 6, then the adjacent ends of the two perforated pipes 140, 140 are connected together, one end of the perforated pipe 140 of a first apparatus 110a, shown on the far left in the drawing, may be capped off with a suitable fitting, and the opposite end 144 of the second apparatus may be provided with a suitable hose fitting (not shown) for connection to a high-pressure water supply.

### Third Embodiment

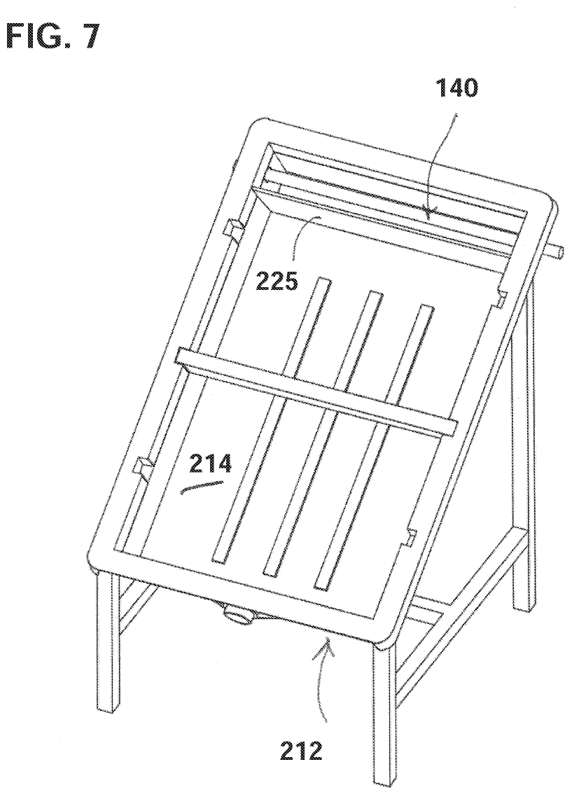

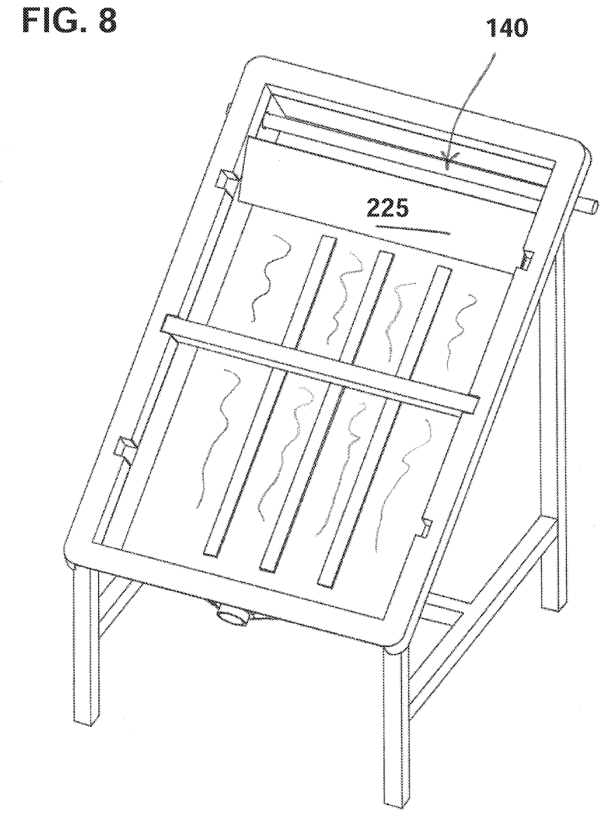

Referring now to FIGS. 7-8, a combined poultry roost and waste routing apparatus 210 according to a third embodiment of the present invention is shown. The apparatus 210 according to the second embodiment is substantially identical to the apparatus 110 according to the second embodiment as previously described, with the exception that an additional component and associated hardware have been added to the apparatus. For this reason, redundant description of identical parts will be avoided.

Optionally, as shown in FIGS. 6-7, a releasable baffle plate 225 may be provided in the main tray member 212 below the water supply manifold 140, for temporarily impeding water flow therepast, and for directing water flow to the floor panel 214 of the main tray member 212 when it is released. Where used, upper end corner portions of the baffle plate 225 are pivotally attached to the opposite side walls of the main tray member 212, and selectively releasable latch members (not shown) are attached to these side walls proximate the lower end corner portions of the baffle plate.

The apparatus 210 may be provided with suitable hardware which temporarily locks the baffle plate 225 in place after the water is released, monitors the water level as it rises behind the baffle plate, and releases the lower edges of the baffle plate when the water reaches a threshold level. The released baffle plate 225 and the flowing rinse water are illustrated in FIG. 8. Where used, operation of the baffle plate may be automated.

To clean or “flush” the main tray member of the apparatus 10, 110 or 210, the chicken keeper opens a valve (not shown) to the water supply manifold 40 or 140, which disperses pressurized water across and down the main tray member 12, 112 or 212 of the apparatus. This flow of water flushes the floor panel 14, 114 or 214 clean, and the waste matter flows into and through the catch basin and out through the drain pipe to be deposited in a desired area.

This flushing operation could be conducted manually by the chicken keeper, or alternatively, it could be automated with the addition of a simple timer to turn the water pressure on at any desired interval. The drainage pipe could be directed to any desired area or into a collection system where the waste material could be collected for fertilizer.

Although the present invention has been described herein with respect to a number of specific illustrative embodiments, the foregoing description is intended to illustrate, rather than to limit the invention. Those skilled in the art will realize that many modifications of the illustrative embodiment could be made which would be operable. All such modifications, which are within the scope of the claims, are intended to be within the scope and spirit of the present invention.

I claim:

1. A combined poultry roost and waste routing apparatus comprising:
a main tray member having a peripheral frame portion and having a catch basin formed therein at a first end portion thereof, the catch basin having a drainage outlet formed therein, the main tray member further comprising a side wall interconnecting the floor and the peripheral frame portion;
a support stand configured to support the main tray member at an inclined angle with the catch basin disposed at a lowermost end thereof;
a plurality of roosting bars attached to the main tray member, and
a water supply manifold operatively attached to a second end of the main tray member opposite the catch basin for selectively supplying rinse water, the water supply manifold including an inlet portion configured to receive a hose connection, and a fluid dispersion member attached to and in fluid communication with the inlet portion, the fluid dispersion member having a plurality of orifices formed therein for selectively releasing said rinse water into the main tray member.

2. The combined poultry roost and waste routing apparatus of claim 1, wherein the main tray member has a plurality of opposed recesses formed therein, and wherein the roosting bars are supported between the recesses of the main tray member.

3. The combined poultry roost and waste routing apparatus of claim 1, wherein the floor of the main tray member has a plurality of reinforcing ribs formed therein.

4. The combined poultry roost and waste routing apparatus of claim 1, wherein the roosting bars are spaced upwardly away from the floor of the main tray member, leaving open spaces therebelow to permit waste to pass along the floor of the main tray member toward the drainage outlet.

5. The combined poultry roost and waste routing apparatus of claim 1, wherein at least part of the water supply manifold extends outwardly from the main tray member.

6. The combined poultry roost and waste routing apparatus of claim 1, further comprising a baffle plate disposed in the main tray member for selectively directing water flow.

7. The combined poultry roost and waste routing apparatus of claim 1, wherein the catch basin is formed in the floor of the main tray member

8. The combined poultry roost and waste routing apparatus of claim 1, wherein the catch basin is formed in a side wall of the main tray member at a lower end thereof.

9. The combined poultry roost and waste routing apparatus of claim 1, wherein the floor of the main tray member has a plurality of reinforcing ribs formed therein.

10. The combined poultry roost and waste routing apparatus of claim 1, further comprising a releasable baffle plate disposed proximate the water supply manifold for temporarily impeding water flow.
